(19) United States
(12) Patent Application Publication
(10) Pub. No.: US 2025/0372288 A1
(43) Pub. Date: Dec. 4, 2025

(54) SOFT MAGNETIC POWDER

(71) Applicant: TOKIN CORPORATION, Shiroishi-shi, Miyagi (JP)

(72) Inventors: Miho CHIBA, Sendai-shi (JP); Akiri URATA, Sendai-shi (JP); Takuya TAKASHITA, Tokyo (JP); Makoto NAKASEKO, Tokyo (JP)

(73) Assignee: TOKIN CORPORATION, Shiroishi-shi, Miyagi (JP)

(21) Appl. No.: 18/836,418

(22) PCT Filed: Feb. 6, 2023
(86) PCT No.: PCT/JP2023/003806

§ 371 Date: Feb. 21, 2025

(30) Foreign Application Priority Data
Feb. 9, 2022 (JP) 2022-018935

(51) Int. Cl. H01F 1/153; B22F 1/05

(52) U.S. Cl. CPC H01F 1/15308; B22F 1/05; H01F 1/15333; B22F 2301/35; B22F 2304/10

(57) ABSTRACT

A soft magnetic powder has a glass transition temperature Tg, a first crystallization starting temperature Tx1 and a second crystallization starting temperature Tx2. The first crystallization starting temperature Tx1 is 400° C. to 475° C. The difference between the first crystallization starting temperature Tx1 and the glass transition temperature Tg (ΔTx=Tx1−Tg) is 50° C. or less. The difference between the second crystallization starting temperature Tx2 and the first crystallization starting temperature Tx1 (ΔT=Tx2−Tx1) is 65° C. to 135° C.

### TECHNICAL FIELD

This invention relates to soft magnetic powder, in particular, to soft magnetic powder which is used in magnetic components.

### BACKGROUND ART

Superior magnetic properties (high saturation flux density and a low core loss) are required for a magnetic core forming a magnetic component. A nanocrystal material is known as a magnetic material which can achieve such magnetic properties. The nanocrystal material can be obtained by heat-treating soft magnetic powder in a nano-crystallization process. The soft magnetic powder which is used to produce the nanocrystal material is disclosed in Patent Document 1 or Patent Document 2, for example.

### PRIOR ART DOCUMENTS

### Patent Documents

Patent Document 1: JP 5632608 B
Patent Document 2: JP 6741108 B

### SUMMARY OF INVENTION

### Technical Problem

Heat treatment in the nanocrystallization process causes self-heating of the soft magnetic powder. Accordingly, in the nanocrystallization process, it is difficult to control a temperature of the soft magnetic powder. As a result, a nanocrystal material obtained by the nanocrystallization process has a problem that properties thereof are easy to vary. In other words, there is a problem that it is difficult to stably carry out nanocrystallization for the soft magnetic powder.

It is therefore an object of the present invention to provide soft magnetic powder which can be stably nanocrystallized.

### Solution to Problem

An aspect of the present invention provides soft magnetic powder, wherein: the soft magnetic powder has a glass transition temperature Tg, a first crystallization starting temperature Tx1 and a second crystallization starting temperature Tx2; the first crystallization starting temperature Tx1 is at least 400° C. and at most 475° C.; a difference ΔTx=Tx1−Tg between the first crystallization starting temperature Tx1 and the glass transition temperature Tg is at most 50° C.; and a difference ΔT=Tx2−Tx1 between the second crystallization starting temperature Tx2 and the first crystallization starting temperature Tx1 is at least 65° C. and at most 135° C.

### Advantageous Effects of Invention

The soft magnetic powder of the present invention has the glass transition temperature Tg, so that an endothermic reaction which accompanies glass transition is caused in a nanocrystallization process and the self-heating in the nanocrystallization is suppressed. In addition to this, the soft magnetic powder of the present invention has the first crystallization starting temperature Tx1 and the second crystallization starting temperature Tx2 which meet predetermined temperature conditions. Accordingly, the soft magnetic powder of the present invention can be stably nanocrystallized, and fine nanocrystals can be sufficiently formed.

An appreciation of the objectives of the present invention and a more complete understanding of its structure may be had by studying the following description of the preferred embodiment and by referring to the accompanying drawings.

### BRIEF DESCRIPTION OF DRAWINGS

FIG. 1 is a graph showing differential scanning calorimetry (DSC) results for soft magnetic powder according to examples of the present invention.

### DESCRIPTION OF EMBODIMENTS

While the invention may be realized in various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Soft magnetic powder according to an embodiment of the present invention is Fe-based soft magnetic alloy powder in which a major element thereof is Fe, and it has an amorphous phase as a main phase thereof. A composition thereof will be described later. The soft magnetic powder of the present embodiment is used to manufacture a magnetic core of a magnetic component, for example. In a manufacturing process for the magnetic core, the soft magnetic powder is heat-treated and nanocrystallized.

The soft magnetic powder according to the present embodiment can be produced by various production methods. The soft magnetic powder may be produced by the atomization method, such as the water atomization method or the gas atomization method, for example. In a powder production process according to the atomization method, at first, materials are prepared. Next, fused alloys are produced by weighing the materials to obtain predetermined compositions (described in Tables 1-8) and fusing them. Then, each of the fused alloys is ejected through a nozzle and divided into alloy droplets by using high pressure gas or water, and thereby producing fine soft magnetic powder.

In the aforementioned powder production process, the gas used for dividing may be an inactive gas, such as argon or nitrogen. Moreover, in order to increase quenching speed, the alloy droplets immediately after the dividing may be rapidly quenched by being brought into contact with a liquid or a solid for quenching, or the alloy droplets may be divided again to be finer. When the liquid is used for the quenching, water or oil may be used, for example. When the solid is used for the quenching, a rotary copper roll or a rotary aluminum plate may be used. However, the liquid or the solid for the quenching is not limited thereto, and various materials may be used.

In the aforementioned powder production process, a particle shape and a particle diameter of the soft magnetic powder can be adjusted by changing production conditions.

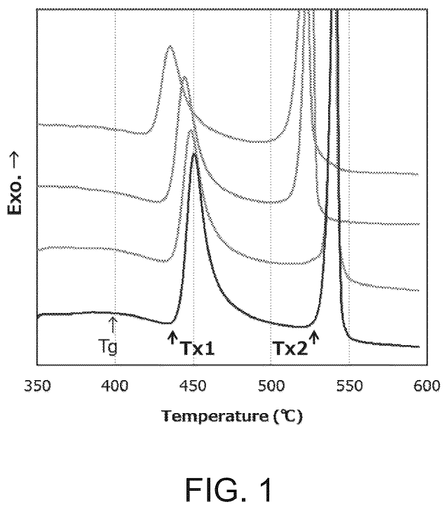

The soft magnetic powder according to the present embodiment has properties as shown in FIG. 1. In detail, the soft magnetic powder according to the present embodiment has a glass transition temperature Tg, a first crystallization starting temperature Tx1 and a second crystallization starting temperature Tx2. Here, the first crystallization starting temperature Tx1 is a temperature depending on a bcc-Fe(—Si) forming reaction (a first crystallization reaction) while the second crystallization starting temperature Tx2 is a temperature depending on a compound forming reaction (a second crystallization reaction).

In the present embodiment, the first crystallization starting temperature Tx1 is within a prescribed range. Moreover, in the present embodiment, the first crystallization starting temperature Tx1 and the glass transition temperature Tg have a predetermined relationship. Furthermore, in the present embodiment, the first crystallization starting temperature Tx1 and the second crystallization starting temperature Tx2 have a predetermined relationship. If these required conditions are met, self-heating of the soft magnetic powder of the present embodiment is suppressed by an endothermic reaction caused together with a glass transition when the soft magnetic powder is heat-treated for nanocrystallization, and fine nanocrystals can be sufficiently formed. Hereinafter, the description will be made in detail about the soft magnetic powder of the present embodiment.

In the present embodiment, the first crystallization starting temperature Tx1 is at least 400° C. and at most 475° C. This is because soft magnetic powder which is produced by means of the atomization method and which has Tx1<400° C. is bad in amorphous nature after quenching and cannot possess good magnetic properties. In addition, this is because soft magnetic powder having Tx1>475° C. tends to increase peripheral atmosphere temperature by heat generation thereof during nanocrystallization (heat treatment) and cause roughening crystal grains and deterioration of soft magnetic properties.

In the present embodiment, the first crystallization starting temperature Tx1 is preferably at least 420° C. and at most 460° C. This is because the soft magnetic powder having the first crystallization starting temperature Tx1 being within this range is good in amorphous nature after quenching, and an increase of peripheral atmosphere temperature caused by heat generation during heat treatment is suppressed, so that soft magnetic properties after the heat treatment become good.

Moreover, in the present embodiment, a difference ΔTx=Tx1−Tg between the first crystallization starting temperature Tx1 and the glass transition temperature Tg is at most 50° C. This is because supercooled liquid region is necessary to use an endothermic reaction which accompanies the glass transition during the crystallization. Moreover, this is because the endothermic reaction and the nanocrystallization (heat generation) reaction are hard to be simultaneously caused when the difference ΔTx is too large and because roughening crystal grains and deterioration of magnetic properties are caused.

The difference ΔTx is preferably at least 20° C. When the difference ΔTx is at least 20° C., endothermic quantity caused by the glass transition is sufficiently large, so that a temperature rise caused by nanocrystallization (heat generation) reaction can be efficiently suppressed, and soft magnetic properties become good.

Furthermore, in the present embodiment, a difference ΔT=Tx2−Tx1 between a second crystallization starting temperature Tx2 and the first crystallization starting temperature Tx1 is at least 65° C. and at most 135° C. This is because when the difference ΔT is lower than 65° C., the second crystallization (compound forming) reaction is accelerated by a temperature rise caused by the first crystallization reaction. Moreover, this is because soft magnetic powder having a difference ΔT over 135° C. is bad in amorphous nature and cannot possess good soft magnetic properties.

In the present embodiment, the difference ΔT is preferably at least 75° C. and at most 120° C. This is because the soft magnetic powder having a difference ΔT being within this range can be heat-treated without causing the second crystallization (compound forming) reaction and because it is good in amorphous nature, so that soft magnetic properties become good.

The soft magnetic powder according to the present embodiment has components which are represented by a composition formula of FeₐSi_{b}P_{c}BₐCuₓCr_{y}Nb_{z}. Here, a, b, c, d, x, y and z are values meeting conditions: 75.4 at %≤a≤80.4 at %, 0 at %≤b≤9 at %, 4.5 at %≤c≤12 at %, 4 at %≤d≤12 at %, 0.3 at %≤x≤0.9 at % and 0 at %≤y+z≤5 at %.

In the soft magnetic powder according to the present embodiment, the element Fe is a principal element and an essential element to provide magnetism. The higher proportion of Fe can increase magnetic flux density Bs and reduce costs of materials. Moreover, when the proportion of Fe is less than 75.4 at %, the first crystallization starting temperature Tx1 becomes high while the difference ΔT becomes small. Accordingly, heat treatment for the soft magnetic powder is difficult, and magnetic properties after the heat treatment are deteriorated. Moreover, when the proportion of Fe is more than 80.4 at %, amorphous nature is deteriorated, and soft magnetic properties are deteriorated.

In the present embodiment, the proportion of the element Fe is preferably 77 at %≤a≤79 at %. This is because the soft magnetic powder in which the proportion of the element Fe is within this range is good in amorphous nature (crystallinity is lower than 3%), the difference ΔT is large (over 75° C.), and the soft magnetic properties after the heat treatment become good.

In the soft magnetic powder according to the present embodiment, the element Si is an element responsible for forming the amorphous phase. Containing the element Si in the soft magnetic powder becomes the difference ΔT large, and the heat treatment can be stably carried out. However, when the proportion of Si is more than 9 at %, amorphous formability is deteriorated, and the soft magnetic powder having the main phase of the amorphous phase cannot be obtained.

In the soft magnetic powder according to the present embodiment, the element P is an essential element responsible for forming the amorphous phase. The element P facilitates formation of fine and uniform nanocrystalline structure after the heat treatment and enables achievement of good magnetic properties. When the proportion of P is less than 4.5 at %, the amorphous formability deteriorated. In addition, formation of the fine and uniform nanocrystalline structure becomes difficult after the heat treatment, so that the magnetic properties are deteriorated. On the other hand, when the proportion of P becomes high, the first crystallization starting temperature Tx1 becomes low. Moreover, when the proportion of P is more than 12 at %, a balance with other metalloid elements becomes, and the amorphous formability is deteriorated. Furthermore, when the proportion of P is more than 12 at %, the saturation magnetic flux density Bs significantly decreases.

In the soft magnetic powder according to the present embodiment, the element B is an essential element responsible for forming the amorphous phase. When the proportion of B is less than 4 at %, formation of the amorphous phase by quenching becomes difficult, and good magnetic properties cannot be achieved. Moreover, when the proportion of B becomes high, the first crystallization starting temperature Tx1 becomes high. When the proportion of B is more than 12 at %, a melting point becomes high, so that it is unpreferable in producing and that the amorphous formability is deteriorated.

In the soft magnetic powder according to the present embodiment, the element Cu is an essential element which contributes formation of the nanocrystalline phase. When the proportion of Cu is less than 0.3 at %, formation of clusters is less during the heat treatment, and uniform nanocrystallization is difficult. Moreover, when the proportion of Cu is more than 0.9 at %, amorphous formability is deteriorated, and it is difficult to obtain the soft magnetic powder having high amorphous nature. In the soft magnetic powder according to the present embodiment, the proportion of the element Cu is preferably less than 0.7 at %. This is because the soft magnetic powder being within this range is good in amorphous nature, uniform nanocrystallization can be carried out, and the soft magnetic properties after the heat treatment become good.

In the soft magnetic powder according to the present embodiment, Cr and Nb are not essential. However, addition of the element Cr forms oxide films on surfaces of grains, and corrosion resistance is improved. Moreover, addition of the element Nb is effective to suppress growth of bcc crystal grains during the nanocrystallization, and formation of fine nanocrystal structure becomes easy. However, addition of Cr and NB reduces the proportion of Fe relatively, and the saturation magnetic flux density Bs decreases. Moreover, the amorphous formability is deteriorated. Accordingly, an additional proportion of Cr and Nb is preferably at most 5 at % in total.

In the soft magnetic powder according to the present embodiment, a part of Fe may be replaced by one or more elements selected from Co, Ni, Zn, Zr, Hf, Mo, Ta, W, Ag, Au, Pd, K, Ca, Mg, Sn, Ti, V, Mn, Al, S, C, O, N, Bi and rare earth elements. Containing such elements facilitates uniform nanocrystallization after the heat treatment. However, in order to limit negative influence of these elements on the magnetic properties and other properties within an acceptable range, the proportion of these elements is preferably at most 3 at % of Fe.

In the soft magnetic powder according to the present embodiment, a mean particle diameter thereof is preferably at least 1 μm and at most 20 μm. Moreover, a crystallinity of the soft magnetic powder according to the present embodiment after quenching is preferably at most 10%. These values are for obtaining good magnetic properties after the heat treatment.

Herein, a quenching speed by the atomization method is over 10³ K/s. Preferably, it is over 10⁴ K/s. This is because when the quenching speed is less than 10³ K/s, an amount of initial crystals formed (mainly bcc-Fe) increases while the amorphous phase decreases. Moreover, this is because a composition of the amorphous phase in the soft magnetic powder deviates from an intended composition, and the glass transition temperature Tg does not appear. Furthermore, this is because the first crystallization starting temperature Tx1 is shifted to a high-temperature side, and/or a temperature peak by the first crystallization goes down.

Soft magnetic powder (hereinafter referred to as samples) was produced as some examples and comparative examples. Evaluation results for them are shown in Tables 1 to 8. The evaluation was carried out as follows.

For each of the samples, thermal analysis was carried out by the use of a differential scanning calorimeter (DSC). In detail, the thermal analysis was carried out for the samples from 40° C. to 730° C. at a temperature increase rate of 10° C. per minute. A glass transition temperature (Tg), a first crystallization starting temperature (Tx1: formation of bcc-Fe(—Si)) and a second crystallization starting temperature (Tx2: formation of compounds, such as Fe—B, Fe—P) were found by this thermal analysis for each of the samples.

Moreover, each of the samples was introduced into an electric furnace and heat-treated in an atmosphere of an inert gas. The heat treatment was carried out by heating each of the samples at a predetermined temperature (described in tables 1-8) and holding it for 30 minutes. Regarding each of the samples, before and after the heat treatment, formed phases were evaluated by an X-ray diffraction (XRD), and a proportion of crystal phase (crystallinity) are calculated by the whole-powder-pattern decomposition (WPPD) method. Furthermore, a saturation magnetization of each of the samples was measured by the use of a vibrating sample magnetometer (VSM), and a saturation magnetic flux density Bs of each of the samples was calculated from the measured saturation magnetization and a density of each of the samples. The density of each of the samples was found by the use of Archimedes method. In addition, particle diameters of the soft magnetic powder were evaluated by the use of a laser particle size analyzer, and a mean particle diameter was calculated from the evaluated particle diameters.

A dust core was produced by the use of each of the samples. The production of the dust core was carried out by a hot press forming or a cold press forming which is described later. Regarding each of the produced dust cores, a core loss Pcv was measured as magnetic property evaluation by the use of a B—H analyzer. The measurement conditions were decided on the basis of the particle diameter of each of the samples and the production method for the dust core (described in tables 1-8). On the basis of measured core losses Pcv, the samples were classified into examples or comparative examples. In detail, in each of Tables 1-6, the samples each of which has the core loss Pcv which is less than or equal to 1250 kW/m³ were classified into the examples. Moreover, in each of Tables 7 and 8, the samples each of which has the core loss Pcv which is less than or equal to 300 kW/m³ were classified into the examples.

The cold press molding was carried out as follows. First, granulation powder was obtained by adding a binder to the soft magnetic powder which is the sample so that the binder is equal to 3% in weight ratio and stirring and mixing them. Here, as the binder, a phenol resin was used. Next, size-controlled granulation powder was obtained by carrying out size control for the granulation powder by the use of a mesh with an opening size of 500 μm. Next, a green compact was produced by the use of the size-controlled granulation powder. In detail, the size-controlled granulation powder of 2.0 g was weighed, and put in a die, and pressed at 490 MPa by the use of a hydraulic automatic press machine to carry out molding. The shape of the green compact was a cylindrical shape having an outer diameter of 13 mm and an inner diameter of 8 mm. Next, the green compact was heated in an atmosphere of an inert gas by the use of an infrared heater. The heating was carried out to a predetermined heat treatment temperature (described in Tables 1-5 and 7-8) at a temperature increase rate of 300° C. per minute and then the heat treatment temperature was held for 20 minutes. This heat treatment caused hardening of the binder and nanocrystallization of the soft magnetic powder, so that the green compact was changed into the dust core. After that, the dust core was cooled by air and taken out from the die.

The hot press molding was carried out as follows. First, insulation-coated powder was obtained by forming insulation coatings on surfaces of soft magnetic powder which is the sample. The formation of the insulation coatings was carried out by dipping the soft magnetic powder in a solution in which silicone resin was diluted by methanol, and by volatilizing the methanol. The coating amount (solid content) of the silicone resin was equal to 1% in weight ratio with respect to the soft magnetic powder. Next, granulation powder was obtained by adding a binder to the insulation-coated powder so that the binder was equal to 1% in weight ratio and stirring and mixing them. Next, a preparative green compact was obtained by carrying out preparative molding for the granulation powder. In detail, the granulation powder of 2.0 g was weighed, and put in a die, and pressed at 150 MPa by using a hydraulic automatic press machine to carry out preparative molding. Next, main molding was carried out for the preparative green compact. In detail, a die having an outer diameter of 13 mm and an inner diameter of 8 mm which was previously heated at a predetermined heat treatment temperature (described in Table 6) by the use of an electric heater was used. The preparative green compact was filled up in the die which is in a state that a lower punch is inserted therein, and an upper punch was furthermore loaded into the die, and a pressure force of 1 GPa was applied to the preparative green contact. The pressed state was held for 30 seconds, and the preparative green compact was changed into a dust core. After that, the dust core was taken out from the die.

Additionally, in addition to phenol resin and silicone resin, any one of various organic or inorganic binders, such as epoxy resin, polyamide resin, polyimide resin, melamine resin, polyurethane resin or liquid glass, may be used as the binder which is used in the cold press molding or the hot press molding. Moreover, the amount of the binder should be decided in consideration of the particle diameter, an applied frequency, an application purpose, etc.

### EXAMPLES

### Examples 1 to 6, and Comparative Examples 1 and 2

As materials of soft magnetic powder for each of Examples 1 to 6 and Comparative Examples 1 and 2 listed in Table 1 below, industrial pure iron, ferrosilicon, ferrophosphorus, ferroboron, ferrochromium and electrolytic copper were prepared. Fused alloy was produced by weighing the materials to obtain alloy composition of each of the Examples 1 to 6 and the Comparative Examples 1 and 2 listed in Table 1 and by fusing them in an atmosphere of argon by induction fusing. Next, by quenching the produced fused alloy by the water atomization method, soft magnetic powder having a mean particle diameter of 8 to 14 μm was produced. Thermal analysis by DSC and crystal phase evaluation by XRD were carried out on the produced soft magnetic powder. Moreover, a dust core was produced by cold press molding using the produced soft magnetic powder, and magnetic properties thereof were evaluated. Furthermore, the produced soft magnetic powder was heat treated at a heat-treatment temperature shown in Table 1 in an atmosphere of argon by an electric furnace, and a saturation magnetic flux density Bs is measured by VSM on the heat-treated soft magnetic powder. Results of the measurement and the evaluation performed on the produced soft magnetic powder are shown in Table 1.

TABLE 1

| | | | | | | | Crystallinity | Heat | Crystalline | Powder |
|---|---|---|---|---|---|---|---|---|---|---|
| | | | | | | | (as Q.) | Treating | phase | Bs(HT) |
| | Alloy Comp. (at %) | Tg | Tx1 | Tx2 | ΔTx | ΔT | [%] | Temp. | (HT) | [T] |
| Comp. | Fe_{81.4}Si_{2.5}B₆P_{8.5}Cu_{0.6}Cr₁ | Non | 396 | 493 | Non | 97 | 23.0 | 400° C. | bcc-Fe + | 1.57 |
| Ex. 1 | | | | | | | | | Com. | |
| Ex. 1 | Fe_{80.4}Si_{3.5}B₆P_{8.5}Cu_{0.6}Cr₁ | 389 | 409 | 510 | 20 | 101 | 9.6 | 410° C. | bcc-Fe | 1.54 |
| Ex. 2 | Fe_{79.4}Si_{4.5}B₆P_{8.5}Cu_{0.6}Cr₁ | 396 | 420 | 517 | 24 | 97 | 6.3 | 420° C. | bcc-Fe | 1.51 |
| Ex. 3 | Fe_{78.4}Si_{5.5}B₆P_{8.5}Cu_{0.6}Cr₁ | 401 | 432 | 523 | 31 | 91 | 1.3 | 435° C. | bcc-Fe | 1.48 |
| Ex. 4 | Fe_{77.4}Si_{6.5}B₆P_{8.5}Cu_{0.6}Cr₁ | 410 | 450 | 527 | 40 | 77 | 0.5 | 450° C. | bcc-Fe | 1.45 |
| Ex. 5 | Fe_{76.4}Si_{7.5}B₈P_{6.5}Cu_{0.6}Cr₁ | 414 | 460 | 530 | 46 | 70 | 0 | 460° C. | bcc-Fe | 1.42 |
| Ex. 6 | Fe_{75.4}Si₉B₈P₆Cu_{0.6}Cr₁ | 425 | 475 | 543 | 50 | 68 | 0 | 475° C. | bcc-Fe | 1.4 |
| Comp. | Fe_{74.9}Si₉B₈P_{6.5}Cu_{0.6}Cr₁ | 427 | 480 | 545 | 53 | 65 | 0 | 480° C. | bcc-Fe + | 1.37 |
| Ex. 2 | | | | | | | | | Com. | |

| | Pcv | Measurement |
|---|---|---|
| | [kW/m³] | Conditions |
| Comp. | 1880 | Cold Core |
| Ex. 1 | | Exiting Conditions, |
| Ex. 1 | 1150 | Frequency: 300 kHz, |
| Ex. 2 | 940 | Magnetic Flax Density: 50 mT |
| Ex. 3 | 710 | Particle Diameter: 8~14 μm |
| Ex. 4 | 650 | |
| Ex. 5 | 780 | |
| Ex. 6 | 1040 | |
| Comp. | 1350 | |
| Ex. 2 | | |

Referring to Table 1, each of the Examples 1 to 6 has a glass transition temperature Tg, a first crystallization starting temperature Tx1 and a second crystallization starting temperature Tx2. In each of the Examples 1 to 6, the first crystallization starting temperature Tx1 is within a range from 400° C. to 475° C. Moreover, in each of the Examples 1 to 6, a difference ΔTx=Tx1−Tg between the first crystallization starting temperature Tx1 and the glass transition temperature Tg is at most 50° C. Moreover, in each of the Examples 1 to 6, the difference ΔTx is at least 20° C. Furthermore, in each of the Examples 1 to 6, a difference ΔT=Tx2−Tx1 between the second crystallization starting temperature Tx2 and the first crystallization starting temperature Tx1 is within a range from 65° C. to 135° C. In addition, in each of the Examples 1 to 6, the crystallinity after quenching (as Q.) is at most 10%. Moreover, in each of the Examples 1 to 6, a mean particle diameter is 8 to 14 μm and within a range from 1 μm to 20 μm. Furthermore, in each of the Examples 1 to 6, the crystal phase is a bcc-Fe phase.

As shown in Table 1, each of the Examples 1 to 6 meets required composition conditions of the present invention. On the other hand, in the Comparative Example 1, a proportion of Fe is equal to 81.4 at % and does not meet the required composition conditions of the present invention. Moreover, in the Comparative Example 2, a proportion of Fe is equal to 74.9 at % and does not meet the required composition conditions of the present invention.

As shown in Table 1, the saturation magnetic flux density Bs of each of the Examples 1 to 6 is at least 1.30 T, and the core loss Pcv of each of the Examples 1 to 6 is at most 1250 W/m³. In other words, each of the Examples 1 to 6 has good magnetic properties.

In particular, the core loss Pcv of each of the Examples 2 to 5 is at most 1000 kW/m³ as shown in Table 1. In each of these Examples 2 to 5, the first crystallization starting temperature Tx1 is within a range from 420° C. to 460° C. Accordingly, the first crystallization starting temperature Tx1 of the soft magnetic powder of the present invention is preferably within the range from 420° C. to 460° C.

Furthermore, the core loss Pcv of each of the Examples 3 and 4 is at most 750 kW/m³ as shown in Table 1. In addition, the crystallinities of the Examples 3 and 4 are equal to 1.3% and 0.5%, respectively, and Examples 3 and 4 are superior in amorphous nature. In each of these Examples 3 and 4, the proportion of Fe is within a range from 77 at % to 79 at %. Therefore, the proportion of Fe in the soft magnetic powder of the present invention is preferably at least 77 at % and at most 79 at %.

On the other hand, the Comparative Example 1 does not have the glass transition temperature Tg as shown in Table 1. Moreover, in the Comparative Example 1, the crystallinity is equal to 23.0% and significantly more than 10%. Moreover, in the Comparative Example 2, the first crystallization starting temperature Tx1 is 480° C. and more than 475° C. Moreover, in the Comparative Example 2, the difference ΔTx between the first crystallization starting temperature Tx1 and the glass transition temperature Tg is 53° C. and more than 50° C. Furthermore, in the Comparative Example 2, the crystal phase includes not only the bcc-Fe phase but also a compound phase (Com.).

As shown in Table 1, in the Comparative Example 1, although the saturation magnetic flux density Bs is at least 1.30 T, the core loss Pcv is equal to 1880 kW/m3 and significantly more than 1250 kW/m³. Moreover, in the Comparative Example 2, although the saturation magnetic flux density Bs is at least 1.30 T, the core loss Pcv is equal to 1350 kW/m³ and more than 1250 kW/m³.

### Examples 7 to 12 and Comparative Example 3

As materials of soft magnetic powder for each of Examples 7 to 12 and Comparative Example 3 listed in Table 2 below, industrial pure iron, ferrosilicon, ferrophosphorus, ferroboron, ferrochromium and electrolytic copper were prepared. Fused alloy was produced by weighing the materials to obtain alloy composition of each of the Examples 7 to 12 and the Comparative Example 3 listed in Table 2 and by fusing them in an atmosphere of argon by induction fusing. Next, by quenching the produced fused alloy by the water atomization method, soft magnetic powder having a mean particle diameter of 8 to 14 μm was produced. Thermal analysis by DSC and crystal phase evaluation by XRD were carried out on the produced soft magnetic powder. Moreover, a dust core was produced by cold press molding using the produced soft magnetic powder, and magnetic properties thereof were evaluated. Furthermore, the produced soft magnetic powder was heat-treated at a heat treatment temperature shown in Table 2 in an atmosphere of argon by an electric furnace, and a saturation density Bs is measured by VSM on the heat-treated soft magnetic powder. Results of the measurement and the evaluation performed on the produced soft magnetic powder are shown in Table 2.

TABLE 2

| | | | | | | | Crystallinity | Heat | Crystalline | Powder |
|---|---|---|---|---|---|---|---|---|---|---|
| | | | | | | | (as Q.) | Treating | phase | Bs(HT) |
| | Alloy Comp. (at %) | Tg | Tx1 | Tx2 | ΔTX | ΔT | [%] | Temp. | (HT) | [T] |
| Ex. 7 | Fe_{80.4}Si₀B₁₀P₈Cu_{0.6}Cr₁ | 360 | 400 | 470 | 40 | 70 | 6.5 | 400° C. | bcc-Fe | 1.56 |
| Ex. 8 | Fe_{79.9}Si_{1.5}B₈P₉Cu_{0.6}Cr₁ | 383 | 420 | 501 | 37 | 81 | 3.3 | 420° C. | bcc-Fe | 1.53 |
| Ex. 9 | Fe_{78.9}Si_{3.5}B₈P₈Cu_{0.6}Cr₁ | 394 | 430 | 517 | 36 | 87 | 2.7 | 430° C. | bcc-Fe | 1.52 |
| Ex. 10 | Fe_{78.9}Si_{5.0}B₆P_{8.5}Cu_{0.6}Cr₁ | 394 | 426 | 519 | 32 | 93 | 4.5 | 430° C. | bcc-Fe | 1.5 |
| Ex. 11 | Fe_{78.9}Si₇B₈P_{4.5}Cu_{0.6}Cr₁ | 408 | 432 | 547 | 24 | 115 | 7.1 | 435° C. | bcc-Fe | 1.51 |
| Ex. 12 | Fe_{79.4}Si₉B_{5.5}P_{4.5}Cu_{0.6}Cr₁ | 400 | 420 | 555 | 20 | 135 | 10.0 | 420° C. | bcc-Fe | 1.56 |
| Comp. | Fe_{79.4}Si_{9.5}B₅P_{4.5}Cu_{0.6}Cr₁ | Non | 418 | 558 | Non | 140 | 15.6 | 420° C. | bcc-Fe | 1.57 |
| Ex. 3 | | | | | | | | | | |

| | Pcv | Measurement |
|---|---|---|
| | [kW/m³] | Conditions |
| Ex. 7 | 1030 | Cold Core |
| Ex. 8 | 880 | Exiting Conditions, |
| Ex .9 | 750 | Frequency: 300 kHz, |
| Ex. 10 | 800 | Magnetic Flax Density: 50 mT |
| Ex. 11 | 950 | Particle Diameter: 8~14 μm |
| Ex. 12 | 1130 | |
| Comp. | 1500 | |
| Ex. 3 | | |

Referring to Table 2, each of the Examples 7 to 12 has a glass transition temperature Tg, a first crystallization starting temperature Tx1 and a second crystallization starting temperature Tx2. In each of the Examples 7 to 12, the first crystallization starting temperature Tx1 is within the range from 400° C. to 475° C. Moreover, in each of the Examples 7 to 12, a difference ΔTx=Tx1−Tg between the first crystallization starting temperature Tx1 and the glass transition temperature Tg is at most 50° C. Furthermore, in each of the Examples 7 to 12, a difference ΔT=Tx2−Tx1 between the second crystallization starting temperature Tx2 and the first crystallization starting temperature Tx1 is within the range from 65° C. to 135° C. In addition, in each of the Examples 7 to 12, the crystallinity after quenching (as Q.) is at most 10%. Moreover, in each of the Examples 7 to 12, a mean particle diameter is 8 to 14 μm and within the range from 1 μm to 20 μm. Furthermore, in each of the Examples 7 to 12, the crystal phase is the bcc-Fe phase.

As shown in Table 2, each of the Examples 7 to 12 meets the required composition conditions of the present invention. On the other hand, in the Comparative Example 3, a proportion of Si is equal to 9.5 at % and does not meet the required composition condition (0 at %≤b≤9 at %) of the present invention.

As shown in Table 2, the saturation magnetic flux density Bs of each of the Examples 7 to 12 is at least 1.30 T, and the core loss Pcv of each of the Examples 7 to 12 is at most 1250 kW/m³. In other words, each of the Examples 7 to 12 has good magnetic properties.

In particular, the core loss Pcv of each of the Examples 8 to 11 is at most 1000 kW/m³ as shown in Table 2. In each of the Examples 8 to 11, the difference ΔT is at least 75° C. and at most 120° C. Accordingly, the difference ΔT in the soft magnetic powder of the present invention is preferably at least 75° C. and at most 120° C.

On the other hand, the Comparative Example 3 does not have the glass transition temperature Tg as shown in Table 2. Moreover, in the Comparative Example 3, the difference ΔT=Tx2−Tx1 between the second crystallization starting temperature Tx2 and the first crystallization starting temperature Tx1 is equal to 140° C. and more than 135° C. Furthermore, in the Comparative Example 3, the crystallinity is equal to 15.6% and more than 15%.

As shown in Table 2, in the Comparative Example 3, although the saturation magnetic flux density Bs is at least 1.30 T, the core loss Pcv is equal to 1500 kW/m³ and significantly more than 1250 kW/m³.

### Examples 13 to 17, and Comparative Examples 4 and 5

As materials of soft magnetic powder for each of Examples 13 to 17 and Comparative Examples 4 and 5 listed in Table 3 below, industrial pure iron, ferrosilicon, ferrophosphorus, ferroboron, ferrochromium and electrolytic copper were prepared. Fused alloy was produced by weighing the materials to obtain alloy composition of each of the Examples 13 to 17 and the Comparative Examples 4 and 5 listed in Table 3 and by fusing them in an atmosphere of argon by induction fusing. Next, by quenching the produced fused alloy with cooling water after it was gas-atomized, soft magnetic powder having a mean particle diameter of 8 to 14 μm was produced. Thermal analysis by DSC and crystal phase evaluation by XRD were carried out on the produced soft magnetic powder. Moreover, a dust core was produced by cold press molding using the produced soft magnetic powder, and magnetic properties thereof were evaluated. Furthermore, the produced soft magnetic powder was heat treated at a heat treatment temperature shown in Table 3 in an atmosphere of argon by an electric furnace, and a saturation density Bs is measured by VSM on the heat-treated soft magnetic powder. Results of the measurement and the evaluation performed on the produced soft magnetic powder are shown in Table 3.

TABLE 3

| | | | | | | | Crystallinity | Heat | | |
|---|---|---|---|---|---|---|---|---|---|---|
| | | | | | | | (as Q.) | Treating | Crystalline | Powder |
| | Alloy Comp. (at %) | Tg | Tx1 | Tx2 | ΔTX | ΔT | [%] | Temp. | phase (HT) | Bs(HT) [T] |
| Comp. | Fe_{79.9}Si₆B_{8.5}P₄Cu_{0.6}Cr₁ | Non | 422 | 550 | Non | 128 | 9.3 | 425° C. | bcc-Fe | 1.61 |
| Ex. 4 | | | | | | | | | | |
| Ex. 13 | Fe_{79.9}Si₆B₈P_{4.5}Cu_{0.6}Cr₁ | 402 | 420 | 546 | 18 | 126 | 8.2 | 420° C. | bcc-Fe | 1.6 |
| Ex. 14 | Fe_{79.9}Si₄B₈P_{6.5}Cu_{0.6}Cr₁ | 395 | 419 | 528 | 24 | 109 | 7.0 | 420° C. | bcc-Fe | 1.57 |
| Ex. 15 | Fe_{79.9}Si₂B₈P_{8.5}Cu_{0.6}Cr₁ | 383 | 418 | 503 | 35 | 85 | 4.4 | 420° C. | bcc-Fe | 1.53 |
| Ex. 16 | Fe_{79.9}Si₂B₆P_{10.5}Cu_{0.6}Cr₁ | 381 | 415 | 490 | 34 | 75 | 3.0 | 415° C. | bcc-Fe | 1.48 |
| Ex. 17 | Fe_{79.4}Si₂B₅P₁₂Cu_{0.6}Cr₁ | 385 | 412 | 477 | 27 | 65 | 6.3 | 415° C. | bcc-Fe | 1.43 |
| Comp. | Fe_{79.4}Si₁B_{5.5}P_{12.5}Cu_{0.6}Cr₁ | 388 | 410 | 470 | 22 | 60 | 12.1 | 410° C. | bcc-Fe + | 1.39 |
| Ex. 5 | | | | | | | | | Com. | |

| | PCV | Measurement |
|---|---|---|
| | [kW/m³] | Conditions |
| Comp. | 1430 | Cold Core |
| Ex. 4 | | Exiting Conditions, |
| Ex. 13 | 1100 | Frequency: 300 kHz, |
| Ex. 14 | 860 | Magnetic Flax Density: 50 mT |
| Ex. 15 | 760 | Particle Diameter: 8~14 μm |
| Ex. 16 | 740 | |
| Ex. 17 | 970 | |
| Comp. | 1550 | |
| Ex. 5 | | |

Referring to Table 3, each of the Examples 13 to 17 has a glass transition temperature Tg, a first crystallization starting temperature Tx1 and a second crystallization starting temperature Tx2. In each of the Examples 13 to 17, the first crystallization starting temperature Tx1 is within the range from 400° C. to 475° C. Moreover, in each of the Examples 13 to 17, a difference ΔTx=Tx1−Tg between the first crystallization starting temperature Tx1 and the glass transition temperature Tg is at most 50° C. Furthermore, in each of the Examples 13 to 17, a difference ΔT=Tx2−Tx1 between the second crystallization starting temperature Tx2 and the first crystallization starting temperature Tx1 is within the range from 65° C. to 135° C. In addition, in each of the Examples 13 to 17, the crystallinity after quenching (as Q.) is at most 10%. Moreover, in each of the Examples 13 to 17, a mean particle diameter is 8 to 14 μm and within the range from 1 μm to 20 μm. Furthermore, in each of the Examples 13 to 17, the crystal phase is the bcc-Fe phase.

As shown in Table 3, each of the Examples 13 to 17 meets the required composition conditions of the present invention. On the other hand, in the Comparative Example 4, a proportion of P is equal to 4 at % and does not meet the required composition condition (4.5 at %≤c≤12 at %) of the present invention. Moreover, in the Comparative Example 5, a proportion of P is equal to 12.5 at % and does not meet the required composition condition (4.5 at %≤c≤12 at %) of the present invention.

As shown in Table 3, the saturation magnetic flux density Bs of each of the Examples 13 to 17 is at least 1.30 T, and the core loss Pcv of each of the Examples 13 to 17 is at most 1250 kW/m³. In other words, each of the Examples 13 to 17 has good magnetic properties.

On the other hand, the Comparative Example 4 does not have the glass transition temperature Tg as shown in Table 3. Moreover, in the Comparative Example 5, the difference ΔT=Tx2−Tx1 between the second crystallization starting temperature Tx2 and the first crystallization starting temperature Tx1 is equal to 60° C. and less than 65° C. In addition, in the Comparative Example 5, the crystallinity after quenching (as Q.) is equal to 12.1% and more than 10%. Furthermore, in the Comparative Example 5, the crystal phase includes not only the bcc-Fe phase but also a compound phase (Com.).

As shown in Table 3, in the Comparative Example 4, although the saturation magnetic flux density Bs is at least 1.30 T, the core loss Pcv is equal to 1430 kW/m³ and more than 1250 kW/m³. Moreover, in the Comparative Example 5, although the saturation magnetic flux density Bs is at least 1.30 T, the core loss Pcv is equal to 1550 kW/m³ and significantly more than 1250 kW/m³.

### Examples 3 and 18 to 21, and Comparative Examples 6 and 7

As materials of soft magnetic powder for each of Examples 3 and 18 to 21 and Comparative Examples 6 and 7 listed in Table 4 below, industrial pure iron, ferrosilicon, ferrophosphorus, ferroboron, ferrochromium and electrolytic copper were prepared. Fused alloy was produced by weighing the materials to obtain alloy composition of each of the Examples 3 and 18 to 21 and the Comparative Examples 6 and 7 listed in Table 4 and by fusing them in an atmosphere of argon by induction fusing. Next, by quenching the produced fused alloy by the water atomization method, soft magnetic powder having a mean particle diameter of 8 to 14 μm was produced. Thermal analysis by DSC and crystal phase evaluation by XRD were carried out on the produced soft magnetic powder. Moreover, a dust core was produced by cold press molding using the produced soft magnetic powder, and magnetic properties thereof were evaluated. Furthermore, the produced soft magnetic powder was heat-treated at a heat treatment temperature shown in Table 4 in an atmosphere of argon by an electric furnace, and a saturation density Bs is measured by VSM on the heat-treated soft magnetic powder. Results of the measurement and the evaluation performed on the produced soft magnetic powder are shown in Table 4.

TABLE 4

| | | | | | | | Crystallinity | Heat | Crystalline | Powder |
|---|---|---|---|---|---|---|---|---|---|---|
| | | | | | | | (as Q.) | Treating | phase | Bs |
| | Alloy Comp. (at %) | Tg | Tx1 | Tx2 | ΔTx | ΔT | [%] | Temp. | (HT) | (HT)[T] |
| Comp. | Fe_{78.9}Si_{7.5}B_{3.5}P_{8.5}Cu_{0.6}Cr₁ | Non | 423 | 521 | Non | 98 | 11.5 | 425° C. | bcc-Fe | 1.49 |
| Ex. 6 | | | | | | | | | | |
| Ex. 18 | Fe₇_{8.9}Si₇B₄P_{8.5}Cu_{0.6}Cr₁ | 398 | 424 | 519 | 26 | 95 | 9.8 | 425° C. | bcc-Fe | 1.49 |
| Ex. 3 | Fe₇_{8.4}Si_{5.5}B₆P_{8.5}Cu_{0.6}Cr₁ | 401 | 432 | 523 | 31 | 91 | 1.3 | 435° C. | bcc-Fe | 1.48 |
| Ex. 19 | Fe₇_{8.4}Si_{5.5}B₈P_{6.5}Cu_{0.6}Cr₁ | 400 | 436 | 540 | 36 | 104 | 1.0 | 440° C. | bcc-Fe | 1.52 |
| Ex. 20 | Fe₇_{9.9}Si₄B₁₀P_{4.5}Cu_{0.6}Cr₁ | 400 | 422 | 540 | 22 | 118 | 7.3 | 425° C. | bcc-Fe | 1.59 |
| Ex. 21 | Fe₇_{9.9}Si₂B₁₂P_{4.5}Cu_{0.6}Cr₁ | 410 | 429 | 544 | 19 | 115 | 7.6 | 430° C. | bcc-Fe | 1.59 |
| Comp. | Fe₇_{9.4}Si₂B_{12.5}P_{4.5}Cu_{0.6}Cr₁ | Non | 435 | 545 | Non | 110 | 13.8 | 435° C. | bcc-Fe | 1.61 |
| Ex.7 | | | | | | | | | | |

| | Pcv | Measurement |
|---|---|---|
| | [kW/m³] | Conditions |
| Comp. | 1260 | Cold Core |
| Ex. 6 | | Exiting Conditions, |
| Ex. 18 | 1070 | Frequency: 300 kHz, |
| Ex. 3 | 710 | Magnetic Flax Density: 50 mT |
| Ex. 19 | 750 | Particle Diameter: 8~14 μm |
| Ex. 20 | 900 | |
| Ex. 21 | 1050 | |
| Comp. | 1390 | |
| Ex. 7 | | |

Referring to Table 4, each of the Examples 3 and 18 to 21 has a glass transition temperature Tg, a first crystallization starting temperature Tx1 and a second crystallization starting temperature Tx2. In each of the Examples 3 and 18 to 21, the first crystallization starting temperature Tx1 is within the range from 400° C. to 475° C. Moreover, in each of the Examples 3 and 18 to 21, a difference ΔTx=Tx1−Tg between the first crystallization starting temperature Tx1 and the glass transition temperature Tg is at most 50° C. Furthermore, in each of the Examples 3 and 18 to 21, a difference ΔT=Tx2−Tx1 between the second crystallization starting temperature Tx2 and the first crystallization starting temperature Tx1 is within the range from 65° C. to 135° C. In addition, in each of the Examples 3 and 18 to 21, the crystallinity after quenching (as Q.) is at most 10%. Moreover, in each of the Examples 3 and 18 to 21, a mean particle diameter is 8 to 14 μm and within the range from 1 μm to 20 μm. Furthermore, in each of the Examples 3 and 18 to 21, the crystal phase is the bcc-Fe phase.

As shown in Table 4, in addition to the Example 3, each of the Examples 18 to 21 meets the required composition conditions of the present invention. On the other hand, in the Comparative Example 6, a proportion of B is equal to 3.5 at % and does not meet the required composition condition (4 at %≤d≤12 at %) of the present invention. Moreover, in the Comparative Example 7, a proportion of B is equal to 12.5 at % and does not meet the required composition condition (4 at %≤d≤12 at %) of the present invention.

As shown in Table 4, the saturation magnetic flux density Bs of each of the Examples 3 and 18 to 21 is at least 1.30 T, and the core loss Pcv of each of the Examples 3 and 18 to 21 is at most 1250 kW/m³. In other words, each of the Examples 3 and 18 to 21 has good magnetic properties.

On the other hand, each of the Comparative Examples 6 and 7 does not have the glass transition temperature Tg as shown in Table 4. Moreover, in the Comparative Examples 6 and 7, the crystallinities are equal to 11.5% and 13.8%, respectively, and more than 10%.

As shown in Table 4, in the Comparative Example 6, although the saturation magnetic flux density Bs is at least 1.30 T, the core loss Pcv is equal to 1260 kW/m³ and more than 1250 kW/m³. Similarly, in the Comparative Example 7, although the saturation magnetic flux density Bs is at least 1.30 T, the core loss Pcv is equal to 1390 kW/m³ and more than 1250 kW/m³.

### Examples 19 and 22 to 27, and Comparative Examples 8 and 9

As materials of soft magnetic powder for each of Examples 19 and 22 to 27 and Comparative Examples 8 and 9 listed in Table 5 below, industrial pure iron, ferrosilicon, ferrophosphorus, ferroboron, ferrochromium and electrolytic copper were prepared. Fused alloy was produced by weighing the materials to obtain alloy composition of each of the Examples 19 and 22 to 27 and the Comparative Examples 8 and 9 listed in Table 5 and by fusing them in an atmosphere of argon by induction fusing. Next, by quenching the produced fused alloy by the water atomization method, soft magnetic powder having a mean particle diameter of 8 to 14 μm was produced. Thermal analysis by DSC and crystal phase evaluation by XRD were carried out on the produced soft magnetic powder. Moreover, a dust core was produced by cold press molding using the produced soft magnetic powder, and magnetic properties thereof were evaluated. Furthermore, the produced soft magnetic powder was heat-treated at a heat treatment temperature shown in Table 5 in an atmosphere of argon by an electric furnace, and a saturation density Bs is measured by VSM on the heat-treated soft magnetic powder. Results of the measurement and the evaluation performed on the produced soft magnetic powder are shown in Table 5.

TABLE 5

| | | | | | | | Crystallinity | Heat | | |
|---|---|---|---|---|---|---|---|---|---|---|
| | | | | | | | (as Q.) | Treating | Crystalline | Powder |
| | Alloy Comp. (at %) | Tg | Tx1 | Tx2 | ΔTx | ΔT | [%] | Temp. | phase (HT) | Bs(HT) [T] |
| Comp. | Fe_{81.0}Si₆B_{8.5}P_{4.5}Cu_{1.0} | Non | 402 | 527 | Non | 125 | 13.5 | 400° C. | bcc-Fe | 1.65 |
| Ex. 8 | | | | | | | | | | |
| Ex. 22 | Fe_{77.1}Si₆B₈P₇Cu_{0.9}Cr₁ | 412 | 455 | 530 | 43 | 75 | 6.8 | 450° C. | bcc-Fe | 1.40 |
| Ex. 23 | Fe_{77.8}Si₆B_{8.5}P₆Cu_{0.70}Cr₁ | 406 | 442 | 512 | 36 | 70 | 4.9 | 440° C. | bcc-Fe | 1.42 |
| Ex. 24 | Fe_{80.32}Si₄B₇P₈Cu_{0.68} | 385 | 401 | 495 | 16 | 94 | 8.9 | 400° C. | bcc-Fe | 1.58 |
| Ex. 19 | Fe_{78.4}Si_{5.5}B₈P_{6.5}Cu_{0.6}Cr₁ | 400 | 436 | 540 | 36 | 104 | 1.0 | 440° C. | bcc-Fe | 1.52 |
| Ex. 25 | Fe_{79.0}Si_{4.7}B_{6.2}P_{8.5}Cu_{0.51}Cr_{1.1} | 408 | 430 | 518 | 22 | 88 | 3.6 | 430° C. | bcc-Fe | 1.5 |
| Ex. 26 | Fe_{79.6}₅Si₅B₉P₆Cu_{0.35} | 428 | 447 | 527 | 19 | 80 | 4.3 | 450° C. | bcc-Fe | 1.56 |
| Ex. 27 | Fe_{79.1}Si₅B₆P_{8.5}Cu_{0.3}Cr₁ | 414 | 440 | 510 | 26 | 70 | 3.2 | 440° C. | bcc-Fe | 1.47 |
| Comp. | Fe_{79.8}Si₅B₉P₆Cu_{0.2} | 439 | 460 | 522 | 21 | 62 | 5.2 | 460° C. | bcc-Fe + | 1.49 |
| Ex.9 | | | | | | | | | Com. | |

| | Pcv | Measurement |
|---|---|---|
| | [kW/m³] | Conditions |
| Comp. | 1470 | Cold Core |
| Ex. 8 | | Exiting Conditions, |
| Ex. 22 | 1200 | Frequency: 300 kHz, |
| Ex. 23 | 1080 | Magnetic Flax Density: 50 mT |
| Ex. 24 | 990 | Particle Diameter: 8~14 μm |
| Ex. 19 | 740 | |
| Ex. 25 | 880 | |
| Ex. 26 | 920 | |
| Ex. 27 | 1000 | |
| Comp. | 1520 | |
| Ex. 9 | | |

Referring to Table 5, each of the Examples 19 and 22 to 27 has a glass transition temperature Tg, a first crystallization starting temperature Tx1 and a second crystallization starting temperature Tx2. In each of the Examples 19 and 22 to 27, the first crystallization starting temperature Tx1 is within the range from 400° C. to 475° C. Moreover, in each of the Examples 19 and 22 to 27, a difference ΔTx=Tx1−Tg between the first crystallization starting temperature Tx1 and the glass transition temperature Tg is at most 50° C. Furthermore, in each of the Examples 19 and 22 to 27, a difference ΔT=Tx2−Tx1 between the second crystallization starting temperature Tx2 and the first crystallization starting temperature Tx1 is within the range from 65° C. to 135° C. In addition, in each of the Examples 19 and 22 to 27, the crystallinity after quenching (as Q.) is at most 10%. Moreover, in each of the Examples 19 and 22 to 27, a mean particle diameter is 8 to 14 μm and within the range from 1 μm to 20 μm. Furthermore, in each of the Examples 19 and 22 to 27, the crystal phase is the bcc-Fe phase.

As shown in Table 5, in addition to the Example 19, each of the Examples 22 to 27 meets the required composition conditions of the present invention. On the other hand, in the Comparative Example 8, a proportion of Cu is equal to 1.0 at % and does not meet the required composition condition (0.3 at %≤x≤0.9 at %) of the present invention. Moreover, in the Comparative Example 9, a proportion of Cu is equal to 0.2 at % and does not meet the required composition condition (0.3 at %≤x≤0.9 at %) of the present invention.

As shown in Table 5, the saturation magnetic flux density Bs of each of the Examples 19 and 22 to 27 is at least 1.30 T, and the core loss Pcv of each of the Examples 19 and 22 to 27 is at most 1250 kW/m³. In other words, each of the Examples 19 and 22 to 27 has good magnetic properties.

In particular, the core loss Pcv of each of the Examples 19 and 24 to 27 is at most 1000 kW/m3 as shown in Table 5. In each of these Examples 19 and 24 to 27, the proportion of Cu is less than 0.7 at %. Accordingly, the proportion of Cu in the soft magnetic powder of the present invention is preferably at least 0.3 at % and less than 0.7 at %.

On the other hand, the Comparative Example 8 does not have the glass transition temperature Tg as shown in Table 5. Furthermore, in the Comparative Example 8, the crystallinity is equal to 13.5% and more than 10%. Moreover, in the Comparative Example 9, a difference ΔTx=Tx1−Tg between the first crystallization starting temperature Tx1 and the glass transition temperature Tg is equal to 62° C. and less than 65° C. Furthermore, in the Comparative Example 9, the crystal phase includes not only the bcc-Fe phase but a compound phase (Com.).

As shown in Table 5, in the Comparative Example 8, although the saturation magnetic flux density Bs is at least 1.30 T, the core loss Pcv is equal to 1470 kW/m³ and more than 1250 kW/m³. Similarly, in the Comparative Example 9, although the saturation magnetic flux density Bs is at least 1.30 T, the core loss Pcv is equal to 1520 kW/m³ and more than 1250 kW/m³.

### Examples 19 and 28 to 31, and Comparative Example 10

As materials of soft magnetic powder for each of Examples 28 to 31 and Comparative Example 10 listed in Table 6 below, industrial pure iron, ferrosilicon, ferrophosphorus, ferroboron, ferrochromium, niobium and electrolytic copper were prepared. Fused alloy was produced by weighing the materials to obtain alloy composition of each of the Examples 28 to 31 and the Comparative Example 10 listed in Table 6 and by fusing them in an atmosphere of argon by induction fusing. Next, by quenching the produced fused alloy by the high-pressure water atomization method, soft magnetic powder having a mean particle diameter of 3 to 8 μm was produced. Thermal analysis by DSC and crystal phase evaluation by XRD were carried out on the produced soft magnetic powder. Moreover, a dust core was produced by hot press molding using the produced soft magnetic powder, and magnetic properties thereof were evaluated. Furthermore, the produced soft magnetic powder was heat-treated at a heat treatment temperature shown in Table 6 in an atmosphere of argon by an electric furnace, and a saturation density Bs is measured by VSM on the heat-treated soft magnetic powder. Results of the measurement and the evaluation performed on the produced soft magnetic powder are shown in Table 6.

TABLE 6

| | | | | | | | Crystallinity | Heat | | |
|---|---|---|---|---|---|---|---|---|---|---|
| | | | | | | | (as Q.) | Treating | Crystalline | Powder |
| | Alloy Comp. (at %) | Tg | Tx1 | Tx2 | ΔTX | ΔT | [%] | Temp. | phase (HT) | Bs(HT) [T] |
| Ex. 28 | Fe_{78.9}Si_{5.5}B₈P_{6.5}Cu_{0.6}Nb_{0.5} | 401 | 440 | 554 | 39 | 114 | 0.5 | 440° C. | bcc-Fe | 1.53 |
| Ex. 19 | Fe_{78.4}Si_{5.5}B₈P_{6.5}Cu_{0.6}Cr₁ | 400 | 436 | 540 | 36 | 104 | 1.0 | 440° C. | bcc-Fe | 1.52 |
| Ex. 29 | Fe_{77.4}Si_{5.5}B₈P_{6.5}Cu_{0.6}Cr₁Nb₁ | 401 | 442 | 563 | 41 | 121 | 0.2 | 450° C. | bcc-Fe | 1.46 |
| Ex. 30 | Fe_{77.9}Si₆B₆P_{6.5}Cu_{0.6}Cr₃ | 399 | 430 | 544 | 31 | 114 | 1.2 | 430° C. | bcc-Fe | 1.41 |
| Ex. 31 | Fe_{75.9}Si₆B₆P_{6.5}Cu_{0.6}Cr₃Nb₂ | 402 | 445 | 580 | 43 | 135 | 0.8 | 450° C. | bcc-Fe | 1.30 |
| Comp. | Fe_{75.4}Si₆B₆P_{6.5}Cu_{0.6}Cr₂Nb_{3.5} | 406 | 452 | 603 | 46 | 151 | 1.1 | 460° C. | bcc-Fe | 1.25 |
| Ex. 10 | | | | | | | | | | |

| | Pcv | Measurement |
|---|---|---|
| | [kW/m³] | Conditions |
| Ex. 28 | 820 | Cold Core |
| Ex. 19 | 910 | Exiting Conditions, |
| Ex. 29 | 760 | Frequency: 1 MHz, |
| Ex. 30 | 950 | Magnetic Flax Density: 50 mT |
| Ex. 31 | 1060 | Particle Diameter: 3~8 μm |
| Comp. | 1300 | |
| Ex. 10 | | |

Referring to Table 6, each of the Examples 19 and 28 to 31 has a glass transition temperature Tg, a first crystallization starting temperature Tx1 and a second crystallization starting temperature Tx2. In each of the Examples 19 and 28 to 31, the first crystallization starting temperature Tx1 is within the range from 400° C. to 475° C. Moreover, in each of the Examples 19 and 28 to 31, a difference ΔTx=Tx1−Tg between the first crystallization starting temperature Tx1 and the glass transition temperature Tg is at most 50° C. Furthermore, in each of the Examples 19 and 28 to 31, a difference ΔT=Tx2−Tx1 between the second crystallization starting temperature Tx2 and the first crystallization starting temperature Tx1 is within the range from 65° C. to 135° C. In addition, in each of the Examples 19 and 28 to 31, the crystallinity after quenching (as Q.) is at most 10%. Moreover, in each of the Examples 19 and 28 to 31, a mean particle diameter is 3 to 8 μm and within the range from 1 μm to 20 μm. Furthermore, in each of the Examples 19 and 28 to 31, the crystal phase is the bcc-Fe phase.

As shown in Table 6, in addition to the Example 19, each of the Examples 28 to 31 meets the required composition conditions of the present invention. On the other hand, in the Comparative Example 10, the sum of a proportion of Cr and a proportion of Nb is equal to 5.5 at % and does not meet the required composition condition (0 at %≤y+z≤5 at %) of the present invention.

As shown in Table 6, the saturation magnetic flux density Bs of each of the Examples 19 and 28 to 31 is at least 1.30 T, and the core loss Pcv thereof is at most 1250 kW/m³. In other words, each of the Examples 19 and 28 to 31 has good magnetic properties.

On the other hand, as shown in Table 6, in the Comparative Example 10, not only the saturation magnetic flux density Bs is equal to 1.25 T and less than 1.30 T but also the core loss Pcv is equal to 1300 kW/m³ and more than 1250 kW/m³.

### Examples 32 to 42

As materials of soft magnetic powder for each of Examples 32 to 42 listed in Table 7 below, industrial pure iron, ferrosilicon, ferrophosphorus, ferroboron, ferrochromium, electrolytic copper, ferrocarbon, Co, zinc, Sn, Ni, Mn, Al and Ti were prepared. Fused alloy was produced by weighing the materials to obtain alloy composition of each of the Examples 32 to 42 listed in Table 7 and by fusing them in an atmosphere of argon by induction fusing. Next, by quenching the produced fused alloy with cooling water after it was gas-atomized, soft magnetic powder having a mean particle diameter of 14 to 20 μm was produced. Thermal analysis by DSC and crystal phase evaluation by XRD were carried out on the produced soft magnetic powder. Moreover, a dust core was produced by cold press molding using the produced soft magnetic powder, and magnetic properties thereof were evaluated. Furthermore, the produced soft magnetic powder was heat-treated at a heat treatment temperature shown in Table 7 in an atmosphere of argon by an electric furnace, and a saturation density Bs is measured by VSM on the heat-treated soft magnetic powder. Results of the measurement and the evaluation performed on the produced soft magnetic powder are shown in Table 7.

TABLE 7

| | | | | | | | Crystallinity | Treating | Crystalline | Powder |
|---|---|---|---|---|---|---|---|---|---|---|
| | Alloy Comp. (at %) | Tg | Tx1 | Tx2 | ΔTx | ΔT | (as Q.)[%] | Heat Temp. | phase (HT) | Bs(HT) [T] |
| Ex. 32 | Fe_{78.9}Si₅B₅P_{8.5}Cu_{0.6}Cr₁C₁ | 386 | 424 | 514 | 38 | 90 | 1.4 | 420° C. | bcc-Fe | 1.54 |
| Ex. 33 | Fe_{77.9}Si₅B₅P_{8.5}Cu_{0.6}Cr₁C₂ | 389 | 431 | 516 | 42 | 85 | 2.1 | 430° C. | bcc-Fe | 1.52 |
| Ex. 34 | Fe_{77.9}Si_{5.5}B₈P_{6.5}Cu_{0.6}Cr₁Co_{0.5} | 398 | 438 | 542 | 40 | 104 | 0.3 | 440° C. | bcc-Fe | 1.55 |
| Ex. 35 | Fe_{78.1}Si_{5.5}B₈P_{6.5}Cu_{0.6}Cr₁Zn_{0.3} | 399 | 437 | 538 | 38 | 101 | 1.1 | 440° C. | bcc-Fe | 1.51 |
| Ex. 36 | Fe_{77.4}Si_{5.5}B₈P_{6.5}Cu_{0.6}Cr₁Sn₁ | 401 | 429 | 536 | 28 | 107 | 0.6 | 430° C. | bcc-Fe | 1.52 |
| Ex. 37 | Fe_{75.4}Si_{5.5}B₈P_{6.5}Cu_{0.6}Cr₁Sn₃ | 400 | 421 | 533 | 21 | 112 | 1.3 | 420° C. | bcc-Fe | 1.47 |
| Ex. 38 | Fe_{77.9}Si_{5.5}B₈P_{6.5}Cu_{0.6}Cr₁Ni_{0.5} | 398 | 435 | 537 | 37 | 102 | 0.8 | 440° C. | bcc-Fe | 1.52 |
| Ex. 39 | Fe_{77.6}Si_{5.5}B₈P_{6.5}Cu_{0.6}Cr₁Mn_{0.8} | 403 | 435 | 541 | 32 | 106 | 1.2 | 440° C. | bcc-Fe | 1.47 |
| Ex. 40 | Fe_{77.39}Si_{6.5}B₆P_{8.5}Cu_{0.6}Cr₁Al_{0.01} | 410 | 450 | 528 | 40 | 78 | 1.5 | 450° C. | bcc-Fe | 1.45 |
| Ex. 41 | Fe_{76.89}Si_{6.5}B_{6.5}P_{8.5}Cu_{0.6}Cr₁Ti_{0.01} | 415 | 458 | 533 | 43 | 75 | 1.0 | 460° C. | bcc-Fe | 1.43 |
| Ex. 42 | Fe_{77.3}Si_{6.5}B₈P_{6.5}Cu_{0.65}Cr₁O_{0.05} | 427 | 460 | 545 | 33 | 85 | 1.2 | 460° C. | bcc-Fe | 1.47 |

| | Pcv [KW/m³] | Measurement Conditions |
|---|---|---|
| Ex. 32 | 163 | Cold Core |
| Ex. 33 | 183 | Exiting Conditions, |
| Ex. 34 | 170 | Frequency: 20 kHz, |
| Ex. 35 | 175 | Magnetic Flax Density: 100 mT |
| Ex. 36 | 145 | Particle Diameter: 14~20 μm |
| Ex. 37 | 150 | |
| Ex. 38 | 138 | |
| Ex. 39 | 165 | |
| Ex. 40 | 188 | |
| Ex. 41 | 178 | |
| Ex. 42 | 173 | |

Referring to Table 7, each of the Examples 32 to 42 has a glass transition temperature Tg, a first crystallization starting temperature Tx1 and a second crystallization starting temperature Tx2. In each of the Examples 32 to 42, the first crystallization starting temperature Tx1 is within the range from 400° C. to 475° C. Moreover, in each of the Examples 32 to 42, a difference ΔTx=Tx1−Tg between the first crystallization starting temperature Tx1 and the glass transition temperature Tg is at most 50° C. Furthermore, in each of the Examples 32 to 42, a difference ΔT=Tx2−Tx1 between the second crystallization starting temperature Tx2 and the first crystallization starting temperature Tx1 is within the range from 65° C. to 135° C. In addition, in each of the Examples 32 to 42, the crystallinity after quenching (as Q.) is at most 10%. Moreover, in each of the Examples 32 to 42, a mean particle diameter is 14 to 20 μm and within the range from 1 μm to 20 μm. Furthermore, in each of the Examples 32 to 42, the crystal phase is the bcc-Fe phase.

As shown in Table 7, in each of the Examples 32 to 42, a part of Fe (less than 3 at %) is replaced with a predetermined element. In detail, each of the Example 32 and the Example 33 contains C. The Example 34 contains Co. The Example 35 contains Zn. Each of the Example 36 and the Example 37 contains Sn. The Example 38 contains Ni. The Example 39 contains Mn. The Example 40 contains Al. The Example 41 contains Ti. The Example 42 contains O.

As shown in Table 7, in each of the Examples 32 to 42, the saturation magnetic flux density Bs is at least 1.30 T, and the core loss Pcv thereof is at most 300 kW/m³. In other words, each of the Examples 32 to 42 has good magnetic properties. It should be noted that measurement conditions for the core loss Pcv in Table 7 are different from those for the core loss Pcv in Tables 1-6.

### Example 43

As materials of soft magnetic powder for an Example 43 listed in Table 8 below, industrial pure iron, ferrosilicon, ferrophosphorus, ferroboron, ferrochromium and electrolytic copper were prepared. Fused alloy was produced by weighing the materials to obtain alloy composition of the Example 43 listed in Table 8 and by fusing them in an atmosphere of argon by induction fusing. Next, by quenching the produced fused alloy by gas-atomization, soft magnetic powder having a mean particle diameter of 14 to 20 μm was produced. Thermal analysis by DSC and crystal phase evaluation by XRD were carried out on the produced soft magnetic powder. Moreover, a dust core was produced by cold press molding using the produced soft magnetic powder, and magnetic properties thereof were evaluated. Furthermore, the produced soft magnetic powder was heat-treated at a heat treatment temperature shown in Table 8 in an atmosphere of argon by an electric furnace, and a saturation density Bs is measured by VSM on the heat-treated soft magnetic powder. Results of the measurement and the evaluation performed on the produced soft magnetic powder are shown in Table 8.

TABLE 8

| | | | | | | | Crystallinity | Heat | | |
|---|---|---|---|---|---|---|---|---|---|---|
| | | | | | | | (as Q.) | Treating | Crystalline | Powder |
| | Alloy Comp. (at %) | Tg | Tx1 | Tx2 | ΔTx | ΔT | [%] | Temp. | phase (HT) | Bs(HT) [T] |
| Ex. 43 | Fe_{77.9}Si_{5.3}B_{6.4}P_{8.7}Cu_{0.6}Cr_{1.1} | 402 | 442 | 519 | 40 | 77 | 1.6 | 400° C. | bcc-Fe | 1.4 |
| | | | | | | | | 425° C. | bcc-Fe | 1.43 |
| | | | | | | | | 450° C. | bcc-Fe | 1.43 |
| | | | | | | | | 475° C. | bcc-Fe | 1.43 |
| | | | | | | | | 500° C. | bcc-Fe + | 1.45 |
| | | | | | | | | | Com. | |

| | Pcv | Measurement |
|---|---|---|
| | [kW/m³] | Conditions |
| Ex. 43 | 248 | Cold Core |
| | 214 | Exiting Conditions, |
| | 158 | Frequency: 20 kHz, |
| | 153 | Magnetic Flax Density: 100 mT |
| | 288 | Particle Diameter: 14~20 μm |

Referring to Table 8, the Example 43 has a glass transition temperature Tg, a first crystallization starting temperature Tx1 and a second crystallization starting temperature Tx2. In the Example 43, the first crystallization starting temperature Tx1 is within the range from 400° C. to 475° C. Moreover, in the Example 43, a difference ΔTx=Tx1−Tg between the first crystallization starting temperature Tx1 and the glass transition temperature Tg is at most 50° C. Furthermore, in the Example 43, a difference ΔT=Tx2−Tx1 between the second crystallization starting temperature Tx2 and the first crystallization starting temperature Tx1 is within the range from 65° C. to 135° C. In addition, in the Example 43, the crystallinity after quenching (as Q.) is at most 10%. Moreover, in the Example 43, a mean particle diameter is 14 to 20 μm and within the range from 1 μm to 20 μm.

As shown in Table 8, in the Example 43, the first crystallization starting temperature Tx1 is equal to 442° C. Heat treatment was carried out on this Example 43 at various temperatures from 400° C. to 500° C. At any treatment temperature, a saturation magnetic flux density Bs which is more than 1.30 T and a core loss Pcv which is less than 300 kW/m³ were obtained. From this, it can be seen that, in the soft magnetic powder of the present invention, good magnetic properties can be obtained even when it is heat-treated at a temperature lower or higher than the first crystallization starting temperature Tx1. However, referring to Table 7 in addition to Table 8, the core loss Pcv is at most 200 kW/m³ when the heat treatment temperature is near the first crystallization starting temperature Tx1. Accordingly, it is preferable that the heat treatment temperature is near the first crystallization starting temperature Tx1.

As mentioned above, the Examples 1 to 43 have excellent magnetic characteristics. From this, it can be said that the soft magnetic powder of each of the Examples 1 to 43 is what can be stably nanocrystallized to form fine nanocrystals sufficiently.

Although the specific explanation about the present invention is made above referring to the embodiments, the present invention is not limited thereto but susceptible of various modifications and alternative forms without departing from the spirit of the invention.

For example, the soft magnetic powder of the present invention may be one in which initial crystals are formed. In this case, inexpensive materials with lower grades may be used as the materials. Moreover, calorific value during heating can be suppressed. In addition, a high saturation magnetic flux density Bs can be expected.

Although the atomization method is used to produce the soft magnetic powder in the aforementioned embodiment, any other method may be used. For example, the soft magnetic powder may be produced by forming a strip from the fused alloy and grinding the strip. In this case, a high saturation magnetic flux density Bs and a high magnetic permeability p can be expected.

In addition, the soft magnetic powder of the present invention may be one in which particles thereof are covered by anything such as glass. Accordingly, an increase in an electric resistance and an improvement in fluidity during manufacturing of a magnetic core are expected.

This application is based on a Japanese Patent Application of JP2022-018935 filed with the Japanese Patent Office on Feb. 9, 2022, the contents of which are incorporated herein in their entirety by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

1. Soft magnetic powder, wherein:
the soft magnetic powder has a glass transition temperature Tg, a first crystallization starting temperature Tx1 and a second crystallization starting temperature Tx2;
the first crystallization starting temperature Tx1 is at least 400° C. and at most 475° C.;
a difference ΔTx=Tx1−Tg between the first crystallization starting temperature Tx1 and the glass transition temperature Tg is at most 50° C.; and
a difference ΔT=Tx2−Tx1 between the second crystallization starting temperature Tx2 and the first crystallization starting temperature Tx1 is at least 65° C. and at most 135° C.

2. The soft magnetic powder as recited in claim 1, wherein the first crystallization starting temperature Tx1 is at least 420° C. and at most 460° C.

3. The soft magnetic powder as recited in claim 1, wherein the difference ΔTx=Tx1−Tg between the first crystallization starting temperature Tx1 and the glass transition temperature Tg is at least 20° C. and at most 50° C.

4. The soft magnetic powder as recited in claim 1, wherein the difference ΔT=Tx2−Tx1 between the second crystallization starting temperature Tx2 and the first crystallization starting temperature Tx1 is at least 75° C.

5. The soft magnetic powder as recited in claim 1, wherein the soft magnetic powder is represented by a composition formula of FeₐSi_{b}P_{c}B_{d}CuₓCr_{y}Nb_{z}, where 75.4 at % a 80.4 at %, 0 at % b 9 at %, 4.5 at % c 12 at %, 4 at % d 12 at %, 0.3 at %≤x≤0.9 at % and 0 at % y+z 5 at %.

6. The soft magnetic powder as recited in claim 5, wherein 77 at %≤a≤79 at %.

7. The soft magnetic powder as recited in claim 6, wherein 3 at % or less of Fe is replaced by one or more elements selected from Co, Ni, Zn, Zr, Hf, Mo, Ta, W, Ag, Au, Pd, K, Ca, Mg, Sn, Ti, V, Mn, Al, S, C, O, N, Bi and rare earth elements.

8. The soft magnetic powder as recited in claim 1, wherein a mean particle diameter is at least 1 μm and at most 20 μm.

9. The soft magnetic powder as recited in claim 1, wherein a crystallinity after quenching is at most 10%.
